(19) United States
(12) Patent Application Publication
(10) Pub. No.: US 2019/0061860 A1
(43) Pub. Date: Feb. 28, 2019

(54) RECREATIONAL SYSTEM FOR USE WITH A VEHICLE

(71) Applicants: CHRIS GREINER, HERMOSA BEACH, CA (US); BLAKE ANDREW OLSON, ARVADA, CO (US)

(72) Inventors: CHRIS GREINER, HERMOSA BEACH, CA (US); BLAKE ANDREW OLSON, ARVADA, CO (US)

(21) Appl. No.: 15/693,120

(22) Filed: Aug. 31, 2017

(51) Int. Cl. B62J 99/00; A01K 27/00

(52) U.S. Cl. CPC B62J 99/00; B62J 2099/0073; A01K 27/005; A01K 27/003

(57) ABSTRACT

A recreational system for training and exercising an animal such as a dog includes a mounting assembly and extension assembly which provides a predetermined separation for the recreational system from a user to enable safe operation of a vehicle such as a bicycle. The mounting assembly may position the extension assembly rearwardly from a user so that a user may operate the bicycle while reducing the fear of accidentally contacting the recreational assembly during operation of the vehicle. The extension assembly may rotate within the mounting assembly when attached thereto, and may rotate freely while being secured to the mounting assembly. The extension assembly may optionally be coupled to the mounting assembly on either side of the mounting assembly, providing increased flexibility for operation and use of the recreational system.

### TECHNICAL FIELD

The technology described herein relates to a recreational system and method for attaching a leash to a vehicle. In particular, the technology provided herein may be used for attaching a leash for a domesticated animal to a human-powered vehicle.

### BACKGROUND

Pet owners often desire ways to provide increased exercise for their pet, such as in some examples a dog. Some breeds of dogs have higher energy levels requiring more time exercising, increased energy expenditure such as running or walking for longer distances, or both. Accordingly, pet owners may often desire ways to increase the energy expenditure of their dog such as by increasing the speed and/or distance that they travel. Some users may choose to use a bicycle or other type of motorized or non-motorized vehicular transportation to increase the speed and/or distance for exercising their dog. However, when attempting to attach a dog leash to a bicycle, the leash or attachment assembly may interfere with safe operation of the bicycle, causing the user of the bicycle to risk accidents and injury.

Previous solutions have provided various ways to attach a dog leash to a bicycle or other vehicle, but have often done so without solving the underlying issue of interfering with the safe operation of the vehicle. In particular, in previous solutions the mounting of the leash to a bicycle may cause the user to inadvertently hit the leash with their legs, feet, or other parts of their body, causing them to tug on the dog's collar or causing the user to lose balance, or uncontrollably steer the bicycle into pedestrian or vehicular traffic or in front of the dog. This may result in serious injury to the user, the dog, or both, and may result in damage to the bicycle. Previous solutions have also reduced the ability to quickly remove the leash attachment mechanism, and have reduced flexibility in attachment of the leash to the bike. Furthermore, previous solutions have rigidly attached the leash mounting assembly to the handlebars, frame, or other place on the bicycle, resulting in decreased ability for a user to control the bicycle. Since previous solutions are rigidly attached to the bicycle, they often require tools to attach or detach the mounting assembly, which may require the user to bring tools along with them, or require the user to keep the leash mounting assembly attached to the bicycle for the duration of the time they are outdoors. This may reduce a users ability to use existing bicycle stands or locks, remove their ability to secure their bicycle to existing structures for storage of bicycle, and therefore reduce a users desire to use the mounting assembly to exercise their dog.

Accordingly, there is a need to provide a quickly removable, flexibly mounted, rotatable leash attachment assembly for recreational enjoyment and exercising of their dog using a vehicle such as bicycle.

The information included in this Background section of the specification, including any references cited herein and any description or discussion thereof, is included for technical reference purposes only and is not to be regarded subject matter by which the scope of the disclosure as defined in the claims is to be bound.

### SUMMARY

The present disclosure is directed to a leash mounting recreational assembly which allows a user to quickly and easily attach a leash mounting device to a vehicle such as a bicycle. By allowing flexibility with mounting the leash mounting device to a vehicle, a user may choose which side the leash mounting assembly is attached to the bicycle. Further, by providing a separation distance from the user, the leash mounting assembly as described herein may reduce the chance that a user contacts the assembly, thereby reducing the chance of accidentally becoming entangled with the leash, inadvertently tugging the dog, causing unwanted steering or uncontrollable operation of the bicycle, and therefore reducing the chance of accident and injury. By allowing for rotation of a main post within the leash mounting assembly, the leash attached to an end of the main post has a reduced chance of wrapping around the main post, and therefore allows the dog to maintain a safe distance from the bicycle and user of the recreational system.

This and other characteristics shall become more readily apparent from the description that follows of a preferred embodiment shown, purely by way of non-limiting example, in the accompanying drawings.

### BRIEF DESCRIPTION OF THE DRAWINGS

FIG. 1 is a perspective view of the recreational system according to an embodiment.

FIG. 2 is a partial exploded view of the recreational system of FIG. 1.

FIG. 3 is a top, partial cross-sectional view of the system of FIG. 1 taken along line A in FIG. 2.

FIG. 4 is a cross-sectional partial view of the system of FIG. 1 taken along line B in FIG. 2.

FIG. 5 is a cross-sectional partial view of the system of FIG. 1 taken along line C in FIG. 2.

FIG. 6 is a partial rear view of the system of FIG. 1.

FIG. 7 is an environmental perspective view of an exemplary use of the system of FIG. 1.

### DETAILED DESCRIPTION

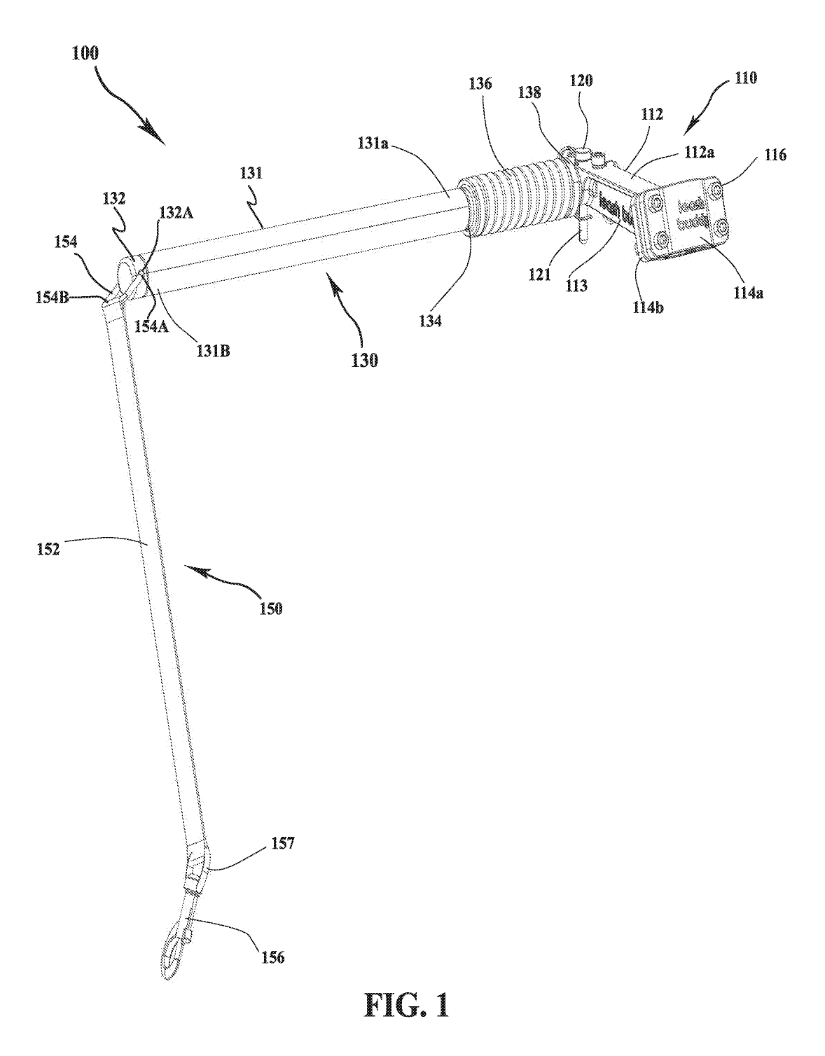

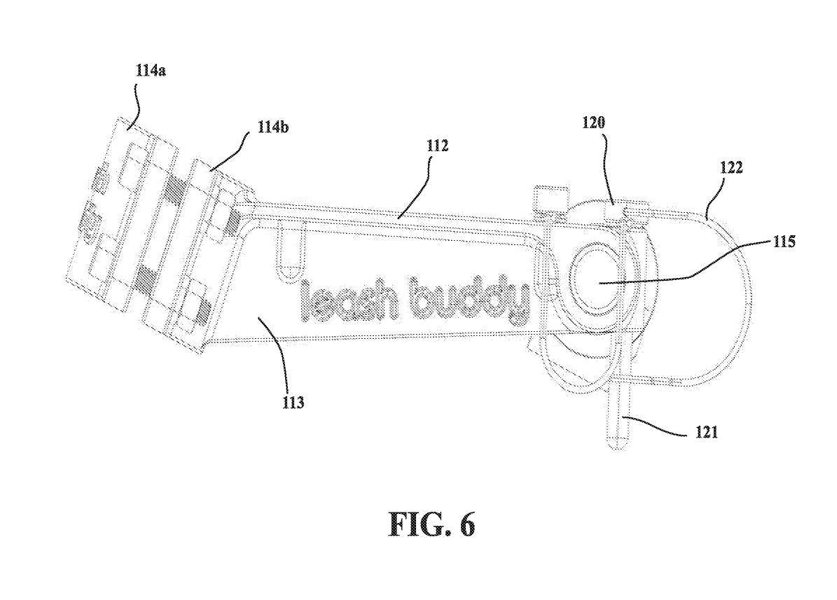

Turning now to the drawings, an example of the recreational system will now be discussed with reference to FIGS. 1-7.

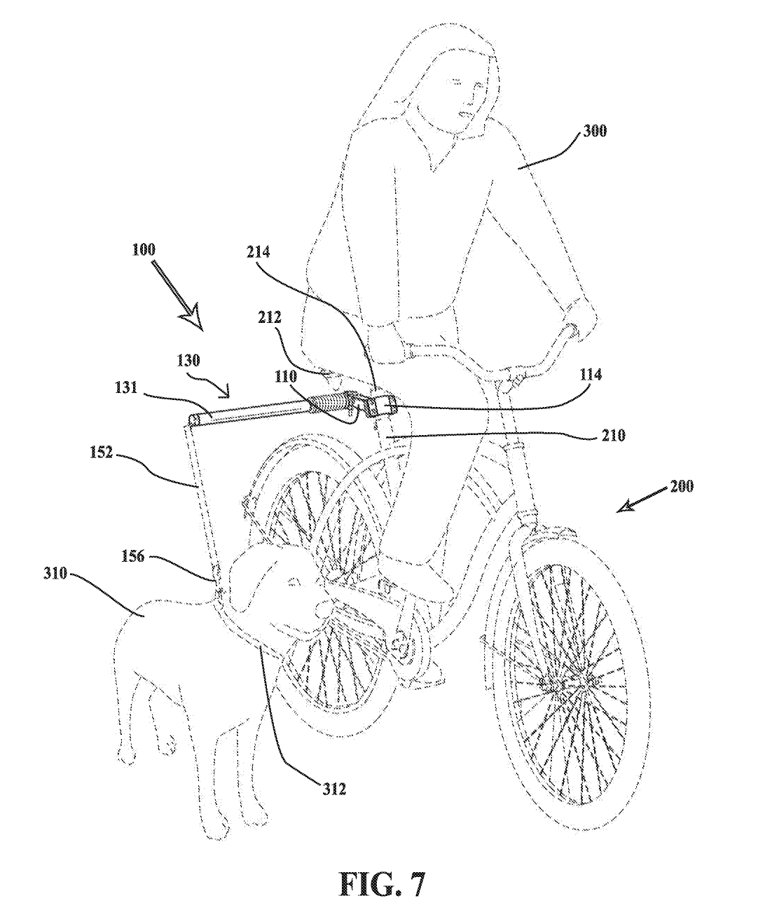

FIG. 1 depicts a perspective view of one example of the animal exercising, training, and recreational system including a leash mounting assembly of the recreational system 100. In some examples, the recreational system may be used with a bicycle or other vehicle to aid a user with exercising and/or training an animal such as a dog. As shown in FIG. 1, the recreational system 100 may include an attachment or mounting assembly 110, an extension assembly 130, and a leash assembly 150. In some examples, the mounting assembly 110 may include a mounting portion for attaching the recreational system 100 to another vehicle such as, for example, a bicycle shown in FIG. 7, as will be discussed in more detail below.

The extension assembly 130 of the recreational system 100 may include a main post 131, an end cap 132, and a resilient member 136. The resilient member 136 may be formed such that it is coupled to a proximal tip 134 of the main post 131 at a first end 131A of the main post 131. In some examples, the proximal tip 134 may extend partially within the resilient member 136 to form a frictional fit, press fit, or interference fit and the like, to be securely retained therein, thereby coupling the proximal tip 134 to the resilient member 136. End cap 132 may be provided at a second end 131B of the main post 131, the second end 131A being opposite the first end 131a. Similarly, end cap 132 may be coupled to the main post 131 and may cooperate with an attachment member 154 of the leash assembly 150 to couple the leash assembly 150 the main post 131. In some examples, the end cap 132 may extend partially within main post 131 to form a frictional fit, press fit, or interference fit and the like, to couple the end cap 132 to the main post 131. In other examples, the end cap 132 may be welded to a second end 131B of the main post 131. In some examples, attachment member 154 may be generally be shaped as a D-ring having proximal portions 154A which cooperate with corresponding holes or apertures 132A provided on the end cap 132, as illustrated in FIG. 1. Accordingly, the attachment member 154 may be selectively removed by resiliently deforming or bending the attachment member 154 to remove proximal 154A portions of the D-ring from the apertures 132A of the end cap 132.

In addition to the attachment member 154, the leash assembly 150 may also include a strap 152 and a clasp 156. In some examples, the attachment member 154 may be shaped and formed to allow attachment of the strap 152 to the end cap 132 of the extension assembly 130 through the attachment member 154. In some examples, as discussed above, the attachment member 154 may be shaped in a D-ring shape having a distal portion 154B for engaging a loop of the leash 152, thereby securing the leash 152 to the end cap 132. Clasp 156 may be coupled to a distal end of the strap, and may include a connection portion 157 to couple the clasp 156 to the strap 152, as shown in FIGS. 1-7.

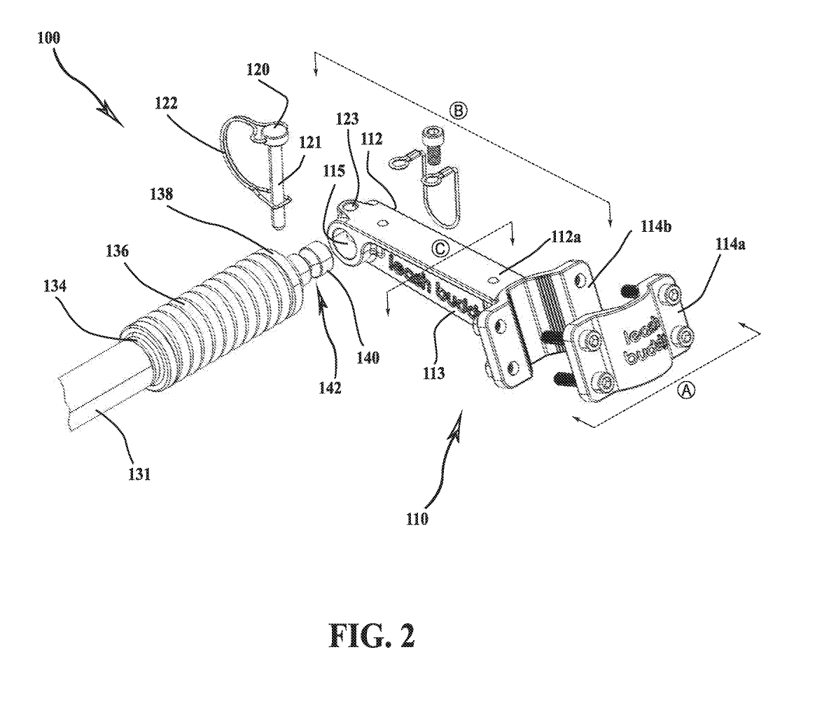

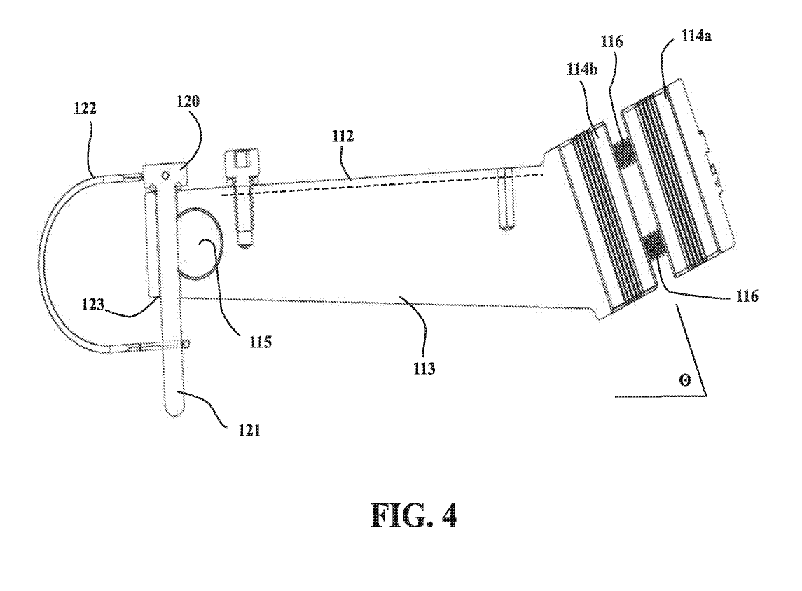

As illustrated in FIGS. 2-6, the mounting assembly 110 may include a main body having a stem 112 and support portion 113 extending outwardly from clamp assembly 114. The stem 112 may be coupled to or integrally formed with the clamp assembly 114. Clamp assembly 114 may be configured for attaching the mounting assembly 110 to an object, such as a bicycle, a post, and the like. In particular, clamp assembly 114 may include a first jaw 114A and a second jaw 114B defining a jaw aperture 117 therebetween. Stem 112 extends in a first direction away from the clamp assembly 114 and in some examples the stem 112 may be integrally formed with the second jaw 114B to form a unitary structure. As depicted in FIG. 4, the first jaw 114A and second jaw 114B may be tilted or angled at an angle θ with respect to the stem 112. Fastening members 116, such as bolts, screws, and the like, may be provided to couple the first jaw 114A to the second jaw 114B, and allow adjustment of the size of the jaw aperture 117. As will be discussed, the angle θ (theta) may correspond to an object to which the mounting assembly 110 may be attached.

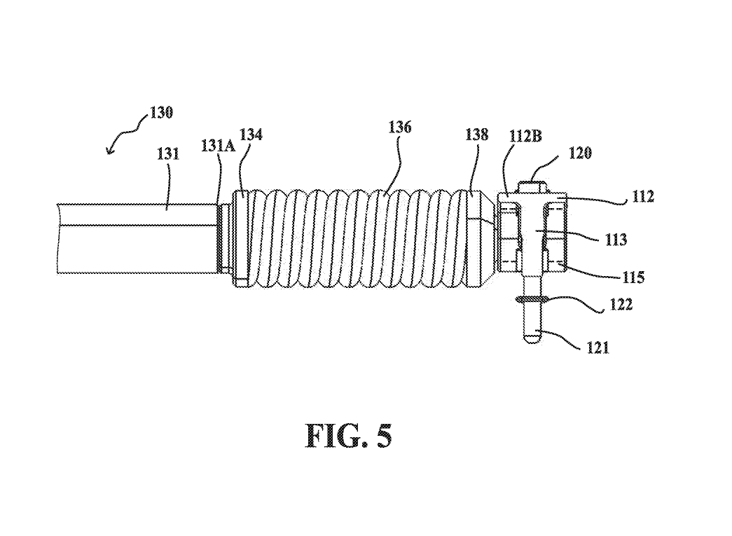

The stem 112 may include a support portion 113 for providing structural support to the stem 112. In some examples, the support portion 113 may be formed integrally with the stem 112 and extend substantially orthogonally to the stem 112. In particular, the stem 112 may be substantially planar with a substantially flat upper surface 112a. Support portion 113 may be substantially planar and extend downward from a bottom surface of the stem 112, forming a substantially right angle between the support portion 113 and stem 112. Accordingly, as shown in FIG. 5, the stem 112 and support portion 113 may form a generally T-shaped cross-section for added strength and structural rigidity. That is, in some examples the stem 112 may have flange portions 112B extending laterally on each side of support portion 113 and substantially orthogonally to support portion 113. However, it is noted that the flange portions 112B are not restricted to being orthogonal, and may extend at an acute of obtuse angle with respect to the support portion 113. Stem 112 may also include a stem aperture 115 (see also FIG. 2) configured to receive a quick connection member 138 of the extension assembly 130, and a retention pin aperture 123 (see FIGS. 2, 4) for receiving a retention pin 120.

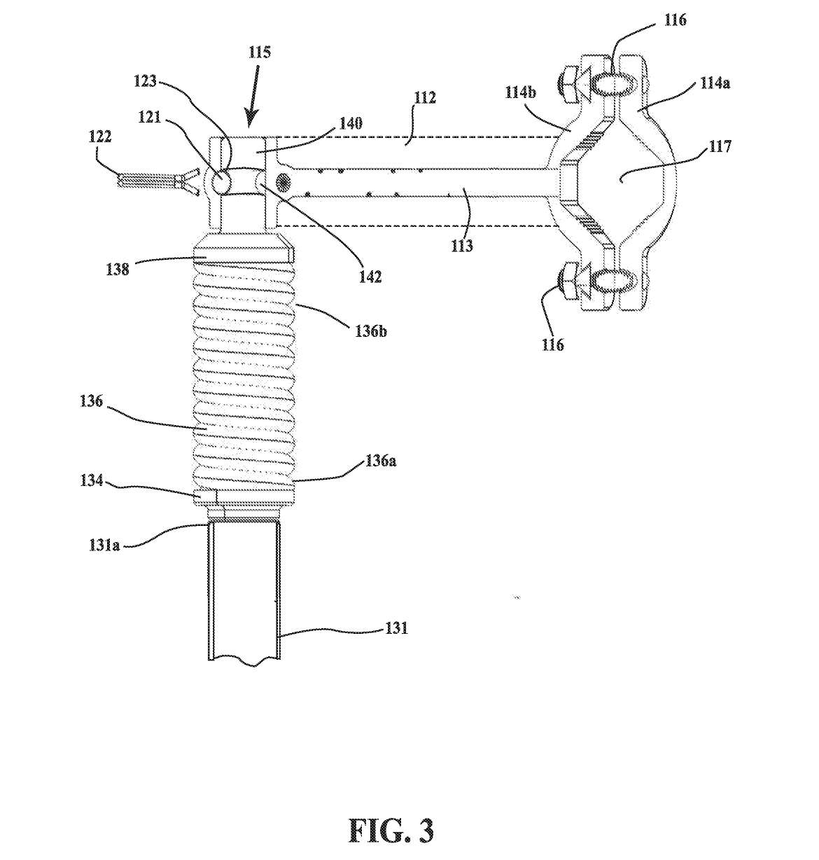

As discussed above, the extension assembly 130 may include a main post 131 and a resilient member 136. The resilient member 136 may be formed such that it is coupled to a proximal tip 134 of the main post 131 at a first end 131a of the main post 131. The proximal tip 134, as depicted in FIG. 3, is constructed such that a portion of the proximal tip 134 extends into an inner volume of the resilient member 136. In some examples, the resilient member 136 may be a coil spring, and the proximal tip 134 may extend within the windings of the resilient member 136 to be securely retained therein. In this way the proximal tip 134, and accordingly the first end 131A of the main post 131, are coupled to a first end 136A the resilient member 136. A quick connection member 138 may be coupled to a second end 136B of the resilient member 136, the second end 136B being opposite the first end 136A as shown in FIGS. 2-3.

Similar to the proximal tip 134 of the main post 131, the quick connection member 138 may be formed such that it is coupled to the resilient member 136 at a second end 136b. In some examples, the quick connection member 138 may extend partially within the resilient member 136 to form a frictional fit, press fit, or interference fit and the like, to be securely retained therein and coupled to the resilient member 136. In some examples, the quick connection member 138 may include a portion which extends within the windings of the resilient member 136 to securely and tightly retain the quick connection member 138 within a portion of the resilient member 136 (see FIGS. 2 and 3). The quick connection member 138 may also include a retention member 140 and groove 142. The groove 142 may be sized and shaped to receive a portion of the retention pin 120 (see FIGS. 3 and 4). In some examples, the groove 142 may extend circumferentially around at least a portion of the circumference of the quick connection member 138 and be sized and shaped to allow the bolt 121 of the retention pin 120 to be inserted at least partially therein. In other examples, the groove 142 may be provided around the entire circumference of the quick connection member 138.

As illustrated in FIGS. 1-3, the quick connection member 138 of the extension assembly 130 may be inserted into the stem aperture 115, and the bolt 121 of retention pin 120 may be inserted into retention pin aperture 123. Upon insertion of the retention pin 120 into retention pin aperture 123, the bolt 121 may be received within a portion of the groove 142 to cooperate with the groove 142 of the quick connection member 138 to retain the quick connection member 138 within the stem aperture 115, while allowing rotation of the quick connection member 138 within the stem aperture 115. That is, the extension assembly 130 may be coupled to the stem 112 and support portion 113 of the mounting assembly 110, and retention pin 120 may be used to prevent removal of the extension assembly 130 from the mounting assembly 110, while allowing the extension assembly 130 to rotate within the stem aperture of the mounting assembly 110. In this way the quick connection member 138 of the extension assembly 130 is rotatably coupled to the mounting assembly 110.

The interaction of the retention pin 120 and the quick connection member 138 is best shown in the partial cross-sectional top view of FIG. 3. When the retention member 140 of the quick connection member 138 has been inserted into the stem aperture 115, the groove 142 may substantially align with the bore of the retention pin aperture 123. The bolt 121 of retention pin 120 may then be inserted into the retention pin aperture 123, and the bolt 121 of the retention pin 120 may be at least partially received into the groove 142 of the quick connection member 138. The diameter of the groove 142 may be less than outer diameter of the retention member 140 and quick connection member 138, such that when the bolt 121 is inserted into the groove 142 the retention member 140 may prevent removal of the quick connection member 138 while allowing axial rotation of the quick connection member 138.

As discussed above, the groove 142 may be provided around the circumference of the quick connection member 138 and allow the quick connection member 138 to rotate about the axis of the quick connection member 138, where the axis of the quick connection member 138 is substantially aligned with a bore axis of the stem aperture 115. Accordingly, when the extension assembly 130 is coupled to the mounting assembly 110, as shown in FIGS. 1-3, the quick connection member 138 may freely rotate within the stem aperture 115, while the enlarged diameter of the retention member 140 relative to the diameter of the groove 142 ensures that the quick connection member 138 is retained within the stem aperture 115. Removal of the extension assembly 130 and the quick connection member 138 may be easily achieved by sliding the retention pin 120 out of the retention pin aperture 123, thereby allowing the quick connection member 138 to be slid out of or removed from the stem aperture 115.

It is noted that although the extension assembly 130 is illustrated in FIGS. 1-6 as being inserted into the stem aperture 115 from a first side, such as a right side, the mounting assembly 110 may be symmetrical and allow for mounting of the extension assembly 130 from either a first side or a second, left side. That is, the stem aperture 115 may extend through the width of the stem 112 of the mounting assembly 110 and allow for bi-directional or bi-lateral insertion of the quick connection member 138 from either side of the stem aperture 115. Further, the position of the groove 142 along the quick connection member 138 is selected such that when the quick connection member 138 is inserted into the pin aperture 115, the groove 142 is substantially aligned with the retention pin aperture 123. This enables the bolt 121 of the retention pin 120 to be at least partially inserted into the groove 142, thereby preventing removal of the quick connection member 138 from the stem aperture while the bolt 121 is in place. Accordingly, when the quick connection member 138 is inserted into the stem aperture 115 from either side of the stem 112, the retention pin 120 may operate to prevent removal of the quick connection member 138 when coupled to the mounting assembly 110.

The retention pin 120 may also include a retention clip 122. When the retention pin 120 is inserted into the retention pin aperture 123, the retention clip 122 may be secured to a bottom end of the bolt 121 to ensure the retention pin 120 cannot inadvertently or accidentally be removed from the retention pin aperture 123. This can ensure a safe operation of the recreational system 100 by ensuring the extension assembly 130 cannot be vibrationally decoupled from the mounting assembly 110 while the retention pin 120 is in place within the retention pin aperture 123 and groove 142.

Turning now to FIG. 7, an exemplary use of the recreational system 100 will now be discussed. As illustrated in FIG. 7, the recreational system 100 may be used in conjunction with a bicycle 200. The bicycle 200 may include a frame 210, seat 212, and seat post 214 for supporting the seat 212 on the frame 210. A person 300 may operate the bicycle in a conventional manner. The recreational system 100 may be substantially the same as discussed above, and may be coupled to the bicycle 200 using the clamp assembly 114 of the mounting assembly 110.

In particular, as discussed above the jaw aperture 117 formed between jaws 114A, 114B of the clamp assembly 114 (FIG. 3) may be sized to receive the seat post 214 therebetween. Fasteners 116 may be configured to adjust the size of the jaw aperture 117 to correspond to the diameter of the seat post 214 to attach the clamp assembly 114 thereto. For example, fasteners 116 may include one or more nuts which allow for dynamic adjustment of the size of the jaw aperture 117. Accordingly, the clamp assembly 114 may be coupled to the seat post 214 and grip the seat post 214 to prevent rotation around the seat post 214 and/or to prevent sliding of the clamp assembly 114 vertically along the seat post 214. As illustrated in FIG. 3, the clamp assembly 114 may include ridges provided on an interior surface of the clamp assembly jaws 114A, 114B to provide added friction between the jaws 114A, 114B and the seat post 214. In some examples the clamp assembly 114 may also include an separate gripping member (not shown) on an interior surface of the clamp assembly jaws 114A,114B to ensure a tight, high-friction fit so that the clamp assembly 114 does not slide or rotate when coupled to the seat post 214. In some examples, the separate gripping member may be a conventional rubber pad, a deformable element, a high-friction element such as grit paper, and/or surface ribbing provided on an interior of the jaws 114a, 114b. In some examples the gripping member may extend at least partially around the inner surface of the jaws 114A, 114B to enclose a seat post 214 of a bicycle 200. In other examples, the gripping member may be a single piece extending around an inner surface of the jaws 114A, 114B to completely surround a seat post 214. In other examples, the gripping member may be formed from two separate pieces provided on inner surfaces of the jaw 114A and jaw 114B, respectively, and disposed between the jaws 114A, 114B and the seat post 214. As discussed above, the tilt angle θ of the clamp assembly 114 (FIG. 4) may correspond to an average or expected angle of inclination of the seat post 214. This may ensure that the mounting assembly 110 is substantially level or parallel to the ground when coupled to the seat post 214. It is noted that although the clamping assembly 114 is discussed as being coupled to a seat post 214, the clamping assembly 114 may also be attached or coupled to a portion of the frame 210 of the bike, such as the portion of the frame 210 which receives the seat post 214.

The extension assembly 130 may be coupled to the mounting assembly 110 as illustrated in FIG. 7, with the stem 112 and support portion 113 of the mounting assembly 110 enabling safe, comfortable positioning of the extension assembly 130, so that it does not interfere with the operation of the bicycle 200. In particular, the extension assembly 130 may provide a predefined separation distance in a first direction to the side of or laterally from the user 300 and the bicycle 200. The mounting assembly 110 may provide a predefined separation distance in a second direction rearwardly from the seat post 214, bicycle frame 210, and user 300 such that when a user 300 operates the bicycle 200, the main post 131 of the extension assembly 130 is positioned at a sufficient separation distance to allow the user 300 to freely operate the bicycle 200 without fear of hitting the extension assembly 130 with their feet and/or legs. This may be particularly important when the resilient member 136, which may be a coil spring, flexes or bends during use and thereby allows main post 131 to articulate about the pivot point established by the resilient member 136.

As described above with respect to FIG. 1, end cap 132 may be coupled to the main post 131 and end cap 132 may cooperate with an attachment member 154 of the leash assembly 150. In this way the leash assembly 150 may be coupled to the main post 131 of the extension assembly 130 via attachment member 154. In some examples, the clasp 156 may be removably coupled to a collar 312 or harness of a dog 310 or other domesticated animal. By doing so, the user 300 may couple a dog 310 to the recreational system 100 to allow for exercising, training, and general recreation. A user 300 may safely operate the bicycle 200 while the dog 310 walks or runs alongside the user 300, maintaining a safe distance between the dog 310 and bicycle 200 by means of the extension assembly 130. The resilient member 136 may flex or bend during operation of the bicycle 200 to prevent relative changes in the dog's location with respect to the bicycle from abruptly tugging on the bicycle 200, and likewise prevent undesirable tugging on the collar 312 of the dog 310 while the dog 310 runs or walks alongside the bicycle 200. The resilient member 136 may also reduce the impulsive forces on the collar 312 resulting from changes in speed or direction of the bicycle 200, and thereby more gently communicate speed or direction changes to the dog 300. This may assist in training the dog 300 to run or walk alongside the bicycle 200, while reducing the chances of injuring the dog 300 when abrupt or strong forces are transmitted to the dog 300 from the bicycle 200 via the recreational system 100.

In use, a user 300 may first couple the mounting assembly 110 to the seat post 214 of the bicycle 200 without attaching the extension assembly 130 thereto. This allows easy placement and alignment of the mounting assembly 110 on the seat post 214, and allows the user 300 to keep the mounting assembly 110 attached to the bike even when the extension assembly 130 is not provided (e.g., the extension assembly 130 is stored for later use, or when the bicycle 200 is parked to reduce the amount of space the bicycle 200 occupies). A user may decide which side the extension assembly 130 should be placed on to ensure safe operation of the bicycle 200. For example, the user 300 may choose to position extension assembly 130 on a right side of the bicycle 200, as shown in FIG. 7, when planning to operate the bicycle on a public road, trail, or bike path. This will ensure the dog 310 is safely positioned off of the roadway and away from pedestrians, traffic, or other vehicles. However, based on the location and other environmental factors, the user 300 may choose to position the extension assembly 130 on a left side of the mounting assembly 110.

As discussed above, when coupled to the mounting assembly 110 the quick connection member 138 and groove 142 may enable the extension assembly 130 to freely rotate within the stem aperture 115. The resilient member 136 may operate to flex, bend, or otherwise dampen the forces exerted by the dog 310 and/or bicycle 200 when in use. In particular, when a user 300 is operating the bicycle 200 and the speed or direction of the bicycle 200 is different than that of the dog 310, the resilient member 136 may allow for a gentler transference of the relative forces between the mounting assembly 110 mounted on the seat post 214 and the dog 310. If a user 300 has to stop unexpectedly, or change direction before the dog 310 has detected the change, the resilient member 136 may allow the main post 131 to articulate slightly while applying a force on the leash assembly 150 and collar 312 of the dog 310. The elastic modulus of the resilient member 136, or the spring constant of a coil spring resilient member 136, may be selected to ensure that the extension assembly 130 may flex a sufficient amount to transmit the force to the dog 310 to gently signal to the dog 310 to change direction and/or speed. In the example where resilient member 136 is a coil spring, the spring constant may be selected or adjusted to ensure safe communication of the force without causing harm or injury to the dog 310, and without transmitting an unsafe jerking motion or other impulsive forces to the seat post 214 of the bicycle 200 if the dog 310 abruptly stops or changes direction.

It is noted that the position of the mounting assembly 110 of the recreational system 100 on the seat post 214 of the bicycle 200 may allow for the forces transferred to and from the dog 310 to be applied near the center of mass of a user. By doing so, the resulting jerking or tugging on the user 300 may be more predictable, and the user 300 may be better able to correct and compensate for these forces.

Although the system discussed above has been in the context of recreational use, it is noted that the recreational system 100 may not be limited to this, and the system may be used for other purposes including training, therapy, and/or exercising of a domesticated animal, such as a dog. Similar uses of the system are contemplated and within the scope of the present disclosure.

Furthermore, although discussed above with respect to attaching the recreational system to a bicycle, it is contemplated that the recreational system may also be mounted to or otherwise removably attached to another type of vehicle. For example, and without limitations, the recreational system 100 may be attached to a bicycle, wheelchair, stroller, Segway®, a tricycle, and the like. Similarly, the recreational system 100 may be used with motorized devices such as, without limitation, mopeds, scooters, electrically powered bicycles, and the like.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of the disclosure. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order, and relative sizes reflected in the drawings attached hereto may vary.

The above specification, examples and data provide a complete description of the structure and use of exemplary embodiments of the disclosure as defined in the claims. Although various embodiments of the claimed disclosure have been described above with a certain degree of particularity, or with reference to one or more individual embodiments, those skilled in the art could make numerous alterations to the disclosed embodiments without departing from the spirit or scope of the claimed disclosure. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the disclosure as defined in the following claims.

We claim:

1. A recreational system for use with a vehicle, the system comprising:
a mounting assembly comprising a stem, a clamp assembly, and a retention pin;
an extension assembly comprising a main post, a resilient member, and a quick connection member;
wherein the quick connection member further comprises a groove provided around at least a portion of the circumference of the quick connection member, the groove positioned such that the retention pin is at least partially inserted within the groove when the quick connection member is coupled to the mounting assembly; and
wherein the quick connection member is rotatably coupled to the mounting assembly.

2. The system of claim 1, wherein the mounting assembly further comprises a retention pin aperture and a stem aperture; and
wherein when the quick connection member is coupled to the mounting assembly, the groove aligns with the retention pin aperture.

3. The system of claim 2, wherein the quick connection member further comprises a retention member, and wherein when the retention pin is at least partially received in the groove, the retention pin prevents removal of the retention member from the mounting assembly.

4. The system of claim 1, wherein the groove is provided around an entire circumference of the quick connection member.

5. The system of claim 1, wherein the vehicle is a bicycle comprising a frame, a seat, and a seat post; and the clamp assembly couples the mounting assembly to the seat post.

6. The system of claim 5, wherein the stem of the mounting assembly is positioned between the extension assembly and the clamp assembly such that the extension assembly is separated from the seat post by a separation distance.

7. The system of claim 1, wherein the mounting assembly further comprises a stem aperture for receiving the quick connection member and a pin aperture for receiving the retention pin, the stem aperture provided substantially orthogonal to the pin aperture.

8. The system of claim 1, wherein the mounting assembly further comprises a stem aperture extending through a width of the mounting assembly such that the quick connection member may be inserted into the stem aperture from a first side or a second side of the mounting assembly, the first side being opposite the second side.

9. The system of claim 1, wherein the clamp assembly further comprises a jaw aperture, the jaw aperture defined by a first jaw and a second jaw of the clamp assembly.

10. The system of claim 9, wherein clamp assembly further comprises at least one fastener, the size of the jaw aperture being adjusted by adjusting the at least one fastener.

11. The system of claim 1, wherein the recreational system further comprises a leash assembly coupled to an end of the extension assembly, the leash assembly comprising an attachment member, a strap, and a clasp.

12. The system of claim 11, wherein the clasp is positioned at a distal end of the leash assembly opposite the attachment member, the clasp configured for removable connection to an object.

13. The system of claim 1, wherein when the quick connection member is coupled to the mounting assembly, the extension assembly may rotate freely about an axis of the quick connection member.

14. The system of claim 1, wherein the main post is configured to provide a predefined separation distance from a user in a first direction; and
wherein the stem is configured to provide a predefined separation distance from a user in a second direction, the second direction substantially orthogonal to the first direction.

15. A method of attaching a leash to a vehicle, the method comprising:
providing a mounting assembly comprising a stem, a clamp assembly, and a retention pin;
providing an extension assembly comprising a main post, a resilient member, and a quick connection member, the quick connection member comprising a groove provided at least around a portion of the circumference of the quick connection member;
positioning the groove such that the retention pin is at least partially inserted into the groove when the quick connection member is coupled to the mounting assembly, thereby rotatably coupling the quick connection member to the assembly.

16. The method of claim 15, wherein the mounting assembly further comprises a retention pin aperture and a stem aperture, wherein the retention pin aperture substantially aligns with the groove when the quick connection member is received within the stem aperture.

17. The method of claim 15, further comprising coupling the leash to the extension assembly, coupling the extension member to the mounting assembly, and coupling the mounting assembly to the vehicle;
wherein the vehicle is a bicycle comprising a frame, a seat, and a seat post, and the mounting assembly is coupled to the seat post; and
providing the mounting assembly between the extension assembly and the clamping mechanism such that the extension assembly is separated from the seat post by a separation distance.

18. The method of claim 15, further comprising providing a stem aperture for receiving the quick connection member and a pin aperture for receiving the retention pin.

19. The method of claim 15, further comprising providing a stem aperture extending through a width of the mounting assembly such that the quick connection member may be inserted into the stem aperture from a first side or a second side of the mounting assembly, the first side being opposite the second side.

20. The method of claim 15, wherein when the quick connection member is coupled to the mounting assembly, the extension assembly may rotate freely about an axis of the quick connection member.
